(19) United States
(12) Patent Application Publication
(10) Pub. No.: US 2021/0141888 A1
(43) Pub. Date: May 13, 2021

(54) Apparatus, System and Method for Authenticating a User

(71) Applicant: Richard Philip Hires, Windsor, CT (US)

(72) Inventor: Richard Philip Hires, Windsor, CT (US)

(21) Appl. No.: 17/093,615

(22) Filed: Nov. 9, 2020

Related U.S. Application Data
(60) Provisional application No. 62/934,200, filed on Nov. 12, 2019.

(51) Int. Cl. G06F 21/34; H04L 29/06; G06F 21/32; H04L 9/32

(52) U.S. Cl. CPC G06F 21/34; H04L 63/083; H04L 63/0861; G06F 2221/2111; H04L 9/3213; H04L 63/0853; H04L 2463/082; G06F 21/32

(57) ABSTRACT

A system for authenticating a user is provided. The system stores first data associated with the user. The first data includes first user data and first behavioral data. The system receives, from a remote authentication engine, an authentication response for authenticating the user and determines second data based on the authentication response. The second data includes second user data and second behavioral data. The system further determines a first plurality of confidence scores, based on a first comparison of the second data and the first data. Furthermore, the system determines a second confidence score based on the first plurality of confidence scores and authenticates the user based on the second confidence score.

### RELATED APPLICATION

This application claims priority from U.S. Provisional Application No. 62/934,200 filed on Nov. 12, 2019 and entitled “Mobile Identity and Transaction Authentication System,” the entire contents of which are hereby fully incorporated herein.

### TECHNOLOGICAL FIELD

The present disclosure generally relates to digital identity management systems, and more particularly relates to user authentication related to digital identity management systems.

### BACKGROUND

Currently, there are various digital identity management systems for authenticating a user. Generally, these digital identity management systems request a government issued identity (ID) card such as driving license, passport, etc. to authenticate the user. As a result, user information associated with the government issued ID card is exposed to the digital identity management systems, which are not owned by the user. Accordingly, the digital identity management systems have an overhead to securely manage the user information to avoid data theft, data breach and the like. Further, these digital identity management systems used in different applications request the user to provide his/her government issued ID card in each application to authenticate the user in a respective application. For instance, a digital identity management system used in a financial transaction application requests the user to provide their government issued ID card to authenticate the user in the financial transaction application and a digital identity management system used in ride sharing application requests the user to provide their government issued ID card to authenticate the user in ride sharing application. Thus, the user's personal information in the form their government issued ID card is exposed to as many applications as the user engages in transactions with, increasing the chances of user information theft and manipulation.

Accordingly, there is a need for providing secure authentication mechanisms and protected use of user's personal information, such as the information about their government issued ID card. To that end, a system to securely store the user information for authenticating the user is needed, such that the overhead of digital identity management systems is avoided and further the stored user information can be easily used to authenticate the user in various applications.

### BRIEF SUMMARY

In order to solve the foregoing problem, the present disclosure provides a system, for instance, a mobile device owned by a user to securely store user information in the mobile device of the user for authenticating the user. To authenticate the user, the mobile device must know an identity of the user. In other words, the mobile device must have the identity of the user to check whether the user is a valid user or not. To that end, the mobile device is configured to verify the identity of the user. For instance, the mobile device obtains user identity information such as facial data, financial card data, government ID card data, and the like and verifies the identity of the user by comparing the facial data with facial data in the government ID card data and by comparing a name of the user in the government ID card data with a name of the user in the financial card data.

During a process of authenticating the user, the mobile device is configured to receive current facial data for the user of the mobile device and authenticate the user based on comparing the current facial data with the facial data stored on the mobile device. As used herein, the user may be the user who owns the mobile or may be a different user using the mobile device during the authentication process. Hereinafter, the current facial data received during the authentication process may be referred to as second facial data and the facial data stored on the mobile device (i.e. received during the identity verification process) may be referred to as first facial data. However, the mobile device configured to authenticate the user by only comparing the second facial data with the first facial data may make it easy for an attacker to mimic the first facial data of the user. To avoid that, it is the objective of some embodiments to determine behavioral data associated with the user during an identity verification process and authenticate the user based on a combination of the first facial data associated with the user, the second facial data associated with the user and the behavioral data associated with the user. Hereinafter, ‘behavioral data’ and ‘first behavioral data’ may be interchangeably used to mean the same. The behavioral data related to one or more behavioral aspects of the user, that can be static and/or dynamic and could be updated continuously. The behavioral data, for example, includes profile data which is a representations of a current latent state of a particular user feature. The feature can be static (like facial landmarks extracted from pictures taken from government issued ID cards) or could be dynamic (like interpretation over time of the user's gait signature). Thus, the behavioral data comprises one or more of location data (also referred to as first location data) associated with the user, gait data (also referred to as first gait data) associated with the user, transaction data (also referred to as first transaction data) associated with the user, network data (also referred to as first network data) associated with the user, connection data (also referred to as first connection data) associated with the user, and the like.

The mobile device is further configured to create an account for the user. In an embodiment, the mobile device obtains the user account information such as user email information, user communication information, user password information and the like and creates the account for the user by generating a digital token associated with the user account information. Hereinafter, the user account information obtained at the time of account creation process and the data obtained during identity verification process which includes: first facial data, the government ID card data, the financial card data, and the first behavioral data; may be collectively referred to as first data (for instance, data of the user that pertains to the identity of the user).

Furthermore, the mobile device is configured to securely store the first data on the mobile device of the user. In an embodiment, the mobile device encrypts, using an encryption algorithm, the first data to generate and store the encrypted first data.

During the process of authenticating the user, the mobile device is configured to receive an authentication response for authenticating the user from a cloud server. The mobile device is configured to render, to the user of the mobile device, a notification to authenticate the user. Once the user approves, the mobile device is configured to determine current data associated with the user of the mobile device. Hereinafter, ‘current data’ and ‘second data’ may be interchangeably used to mean the same. The current data comprises current facial data (also referred to as second user data) and current behavioral data (also referred to as second user data). The current behavioral data comprises one or more of current location data (also referred to as second location data), current gait data (also referred to as second gait data), current transaction data (also referred to as second transaction data), current network data (also referred to as second network data), and the like.

The mobile device is further configured to determine a first plurality of confidence scores by comparing the second data with the first data stored on the mobile device. The first plurality of confidence scores comprises two or more of a facial confidence score, a location confidence score, a gait confidence score, a transaction confidence score, a network confidence score, or a combination thereof.

The mobile device is configured to determine a second confidence score based on the first plurality of confidence scores. Therefore, a single final confidence score (i.e. the second confidence score) is determined from the first plurality of confidence scores.

The mobile device is configured to authenticate the second user based on the second confidence score. In an embodiment, the mobile device compares the second confidence score with a threshold confidence score to authenticate the user.

In this way, the system is configured to securely store data of the user (i.e. the first data pertaining to the identity of the user) on the mobile device for authenticating the user such that the overhead of maintaining the data of the user on the digital identity management systems are avoided without compromising on the security of the data. Further, because the user's data is securely stored on the user's mobile device and if it is shared to any entity outside of the user's mobile device, the data is first encrypted using the generated digital token, thus chances of data theft and data breaches can also be minimized. Further, the system may use the stored user data to authenticate the user in various applications.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram showing an example architecture of a system for authenticating a user, in accordance with one or more example embodiments;

FIG. 2A illustrates a block diagram of a mobile device for authenticating the user, in accordance with one or more example embodiments;

FIG. 2B illustrates operations associated with a facial data module, in accordance with one or more example embodiments;

FIG. 2C illustrates operations associated with a government identity card data module, in accordance with one or more example embodiments;

FIG. 2D illustrates operations associated with a financial data module, in accordance with one or more example embodiments;

FIG. 2E illustrates operations associated with a verification module, in accordance with one or more example embodiments;

FIG. 2F illustrates a block diagram of an encryption module for data encryption, in accordance with one or more example embodiments;

FIG. 2G illustrates a block diagram of an authentication module for authenticating the user, in accordance with one or more example embodiments;

FIG. 2H illustrates a block diagram of a confidence score evaluation module for determining a final confidence score, in accordance with one or more example embodiments;

FIGS. 3A-3B illustrate an exemplary working environment of the mobile device for authenticating the user while purchasing medicine in pharmacy, in accordance with one or more example embodiments;

FIG. 4 illustrates an exemplary working environment of the mobile device for authenticating the user while performing a financial transaction, in accordance with one or more example embodiments;

FIG. 5 illustrates a block diagram of a cloud server exemplarily illustrated in FIG. 4, in accordance with one or more example embodiments;

FIG. 6 illustrates an exemplary working environment of the mobile device for authenticating the user in ride share application, in accordance with one or more example embodiments;

FIG. 7 illustrates a block diagram of a driver's mobile device exemplarily illustrated in FIG. 6 during diver's work session initiation, in accordance with one or more example embodiments;

FIG. 8 illustrates a block diagram of a driver's mobile device exemplarily illustrated in FIG. 6 after receiving the pickup request, in accordance with one or more example embodiments;

FIG. 9 illustrates a block diagram of a cloud server exemplarily illustrated in FIG. 6, in accordance with one or more example embodiments;

FIGS. 10A-10C illustrate a flowchart of a method for authenticating the user, in accordance with one or more example embodiments;

FIG. 11 illustrates a flowchart of a method for on boarding the user, in accordance with one or more example embodiments; and

FIG. 12 illustrates a flowchart of a method for authenticating the user, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

FIG. 1 illustrates a block diagram 1000 showing an example architecture of a system for authenticating a user, in accordance with one or more example embodiments. As illustrated in FIG. 1, the block diagram 1000 comprises a mobile device 1001, a cloud server 1003, and a network 1005. The mobile device 1001 comprises a smart phone, a laptop, a computer, a tablet, a smart watch, and the like. Hereinafter, ‘mobile device’ and ‘system’ may be interchangeably used to mean the same. The mobile device 10001 may be communicatively coupled to the cloud server 1003 via the network 1005. The cloud server 1003 comprises a server (for instance, a backend server, a remotely located server, or the like), group of servers, distributed computing system, and/or other computing system. Hereinafter, ‘cloud server’ and ‘remote authentication engine’ may be interchangeably used to mean the same.

The network 1005 may be wired, wireless, or any combination of wired and wireless communication networks, such as cellular, Wi-Fi, internet, local area networks, or the like. In some embodiments, the network 1005 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The mobile device 1001 is communicatively coupled to the cloud server 1003 through the network 1005 for the purposes of authenticating a user. All user related data required for authentication is stored in the mobile device 1001, and if needed, is shared with the cloud server 1003 after encryption in the form of an encrypted blob. Further, after encryption, a digital token, such as a digital identification (ID) is generated which is used to identify the user in the cloud server 1003. When multiple users are using the cloud server 1003 as a provider of authentication services, each individual user can be identified by their respective digital tokens, and use the combination of cloud server 1003 and the mobile device 1001 for authenticating their respective user in a plurality of applications.

FIG. 2A illustrates a block diagram 2000a of a mobile device 2001 for authenticating the user, in accordance with one or more example embodiments. The mobile device 2001 may be the mobile device 1001 illustrated in FIG. 1. The cloud server 2003 may be the cloud sever 1003 illustrated in FIG. 1. The mobile device 2001 may include a processing means such as at least one processor 2101 and a storage means such as a memory 2201. The processor 2101 may be embodied in several different ways. For example, the processor 2101 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 2101 may include one or more processing cores configured to perform independently. A multi-core processor may enable multiprocessing within a single physical package. Additionally, or alternatively, the processor 2101 may include one or more processors configured in tandem via a bus to enable independent execution of instructions, pipelining and/or multithreading.

Additionally, or alternatively, the processor 2101 may include one or more processors capable of processing large volumes of workloads and operations to provide support for big data analysis. In an example embodiment, the processor 2101 may be in communication with the memory 2201 via a bus. The memory 2201 may be non-transitory and may include, for example, one or more volatile and/or non-volatile memories. In other words, for example, the memory 2201 may be an electronic storage device (for example, a computer readable storage medium) comprising gates configured to store data (for example, bits) that may be retrievable by a machine (for example, a computing device like the processor 2101). The memory 2201 may be configured to store information, data, content, applications, instructions, or the like, for enabling the mobile device 2101 to carry out various functions in accordance with an example embodiment of the present invention. For example, the memory 2201 may be configured to buffer input data for processing by the processor 2101. As exemplarily illustrated in FIG. 2A, the memory 2201 may be configured to store computer-executable instructions for execution by the processor 2101. As such, whether configured by hardware or software methods, or by a combination thereof, the processor 2101 may represent an entity (for example, physically embodied in circuitry) capable of performing operations according to an embodiment of the present invention while configured accordingly. Thus, for example, when the processor 2101 is embodied as an ASIC, FPGA or the like, the processor 2101 may be specifically configured hardware for conducting the operations described herein. Alternatively, as another example, when the processor 2101 is embodied as an executor of software instructions, the instructions may specifically configure the processor 2101 to perform the algorithms and/or operations described herein when the instructions are executed. However, in some cases, the processor 2101 may be a processor specific device (for example, a mobile terminal or a fixed computing device) configured to employ an embodiment of the present invention by further configuration of the processor 2101 by instructions for performing the algorithms and/or operations described herein. The processor 2101 may include, among other things, a clock, an arithmetic logic unit (ALU) and logic gates configured to support operation of the processor 2101.

The processor 2101 is configured as one or more of an identity verification module 2111, an account creation module 2121, an encryption module 2131, and/or an authentication module 2141 while executing the computer-executable instructions stored on the memory 2201. In some embodiments, the computer-executable instructions relate to an application or app, stored in the memory 2201, which includes all the instructions configured to cause the processor 2101 to operate the different modules and their functions embodied therein. The identity verification module 2111 verifies an identity of the user by requesting user identity information. As used herein, the user is an individual who owns the mobile device 2001. The identity verification module 2111 comprises a facial data module 2111a, a government identity card data module 2111b, and a financial data module 2111c for requesting the user identity information. Further, the identity verification module 2111 comprises a verification module 2111d for verifying the identity of the user. Further, operations or steps associated with each of the modules 2111a-2111d is illustrated in FIGS. 2B-2E, respectively.

FIG. 2B illustrates operations 2000b associated with the facial data module 2111a, in accordance with one or more example embodiments. The facial data module 2111a determines facial data (i.e. user image data) of the user using known facial recognition techniques. The facial data may include visual features of the user, preferably visual features of a face of the user. Hereinafter, ‘facial data’ and ‘first facial data’ may be interchangeably used to mean the same. Starting at block 2111a-0, the facial data module 2111a turns-on a camera (preferably, a front-facing camera) associated with the mobile device 2001. Further, at block 2111a-0, the facial data module 211a may render a preview window on the mobile device 2001 to properly frame a selfie of the user. At block 2111a-1, the facial data module 2111a records a video and 3D depth map for verifying realistic movements of the face of the user in a 3D space. In an alternate embodiment, the facial data module 2111a, at block 2111a-1, may capture a picture (for instance, a 2D image also referred to as the selfie) of the user. At block 2111a-2, the facial data module 2111a verifies the realistic movements of the face of the user in the 3D space. In other words, the facial data module 2111a, at block 2111a-2, verifies liveness' of the user. The verification of liveness' of the user is a process that ensures that a subject (i.e. the face of the user) is moving realistically within the 3D space. The verification of liveness' of the user is used to identify and avoid a scenario, for instance, a person holding a photo of the user. In an embodiment, the facial data module 2111a captures the realistic movements of the face in the 3D space using 3D depth sensors of the mobile device 2001. To that end, the verification of ‘liveness’ of the user includes verifying that the depth map is consistent in the 3D space. Accordingly, the verification of liveness' of the user is used to identify and avoid a scenario, for instance, viewing the video of the user on another device.

Once the realistic movements of the face of the user in the 3D space are verified, the facial data module 2111a extracts or determines, at block 2111a-3, the facial data of the user. In other words, the facial data module 2111a determines the facial data, in response to determining a ‘real’ user is being viewed. In an embodiment, the facial data module 2111a maps the face of the user using facial landmarks (for instance, sixty-eight specific points based on a centered 2D image of the face) to determine the facial data. The facial data module 2111a may further map the face of the user using a 3D point cloud of the 3D depth map to determine the facial data if the 3D point cloud is available. The determined facial data may be stored on the memory 2201 for authenticating the user. At step 2111a-4, the facial data module 2111a discards raw data associated with the video and/or the selfie. The raw data associated with the video and/or the selfie may include video frames or a raw selfie image that do not contribute to determine the facial data. In this way, the facial data module 2111a determines the facial data associated with the user.

FIG. 2C illustrates operations 2000c associated with the government identity card data module 2111b, in accordance with one or more example embodiments. The government identity card data module 2111b determines government identity card data associated with a government issued identity card of the user. The government issued identity card includes a driving license, a passport, a green card, and the like. In an embodiment, the government identity card data module 2111b verifies whether the government issued identity card of the user is valid or not and determines the government identity card data associated with the government issued identity card, if the government issued identity card is valid. To that end, the government identity card data module 2111b is trained to recognize a variety of government issued identity cards that are specific to a region.

Starting at block 2111b-0, the government identity card data module 2111b turns-on a camera (preferably, a rear-facing camera) associated with the mobile device 2001. At block 2111b-1, the government identity card data module 2111b records a video of front side of the government issued identity card. At block 2111b-2, the government identity card data module 2111b records a video of backside of the government issued identity card. The videos of front side of the government issued identity card and backside of the government issued identity card is used to verify a 3D shape of the government issued identity card. To that end, the government identity card data module 2111b identifies and discards a photocopy of the government issued identity card.

Further, in some example embodiments, the government identity card data module 2111b may generate a glare-free image of the government issued identity card using the videos of front side of the government issued identity card and backside of the government issued identity card. Since, single images (for instance, an image of front side of the government issued identity card and an image of backside of the government issued identity card) are susceptible to various glare patterns that obscures a part of information on the government issued identity card, the government identity card data module 2111b instructs the user to slowly and slightly rotate the government issued identity card in front of the camera, which has an effect of moving the glare around all other areas of the government issued identity card. Further, the government identity card data module 2111b may stitch multiple images that do not contain any glare effect to generate the glare-free image of the government issued identity card.

In some example embodiments, if the government issued identity card is plastic coated, the government identity card data module 2111b instructs the user to rotate the government issued identity card slightly in all direction to generate a holographic image of the government identity issued card data embedded within the plastic coating.

At block 2111b-3, the government identity card data module 2111b checks whether the government issued identity card is valid. In other words, the government identity card data module 2111b may authenticate the government issued identity card.

Once the government issued identity is determined as valid, the government identity card data module 2111b extracts or determines, at block 2111b-4, the government identity card data associated with the government identity card. In an embodiment, the government identity card data module 2111b extracts, from the government issued identity card, a name of the user, date of birth of the user, facial data of the user and the like as the government identity card data. For instance, the government identity card data module extracts the name of the user and the date of birth of the user and the like using computer vision algorithms (i.e. Optical Character Recognition (OCR) algorithm and the like). In an alternate embodiment, the government identity card data module 2111b extracts a barcode associated with the government identity card as the government identity card data, if the government identity card has the barcode that encodes the name of the user, the date of birth of the user, the facial data of the user, and the like. Further, the determined government identity card data is stored in the memory 2201 for verifying the identity of the user.

At block 2111b-5, the government identity card data module 2111b discards raw data associated with the video of front side of the government issued identity card and the video of backside of the government issued identity card. The raw data associated with the video of front side of the government issued identity card and the video of backside of the government issued identity card may include video frame(s) that do not contribute to determination of the government identity card data. In this way, the government identity card data module 2111b determines the government identity card data.

FIG. 2D illustrates operations 2000d associated with the financial data module 2111c, in accordance with one or more example embodiments. The financial data module 2111c determines financial card data associated with one or more financial cards of the user. The one or more financial cards include one or more of a debit cards, a credit card, and the like.

Starting at block 2111c-0, the financial data module 2111c turns-on the camera (preferably, the rear-facing camera) associated with the mobile device 2001. At block 2111c-1 and at block 2111c-2, the financial data module 2111c records a video of front side of each financial card and a video of backside of each financial card as described in the detailed description of FIG. 2C for discarding a photocopy of each financial card, for generating a glare-free image of each financial card, and/or for generating a holographic image of each financial card.

At block 2111c-3, the financial data module 2111c checks whether each financial card is valid. In other words, the financial data module 2111c may authenticate each financial card.

Once at least one financial card is determined as valid, the financial data module 2111c extracts or determines, at block 2111c-4, the financial card data associated with the at least one financial card. For instance, the financial data module 2111c extracts, using the computer vision algorithms (such as the OCR and the like), a name of the user, a financial card number, an expiration date, a CVV (Card Verification Value) number, an issuing bank, and the like for each of the at least one financial card as the financial card data. Further, the determined financial card data is stored in the memory 2201 for verifying the identity of the user and for verifying whether the user has a valid financial account.

At block 2111c-5, the financial data module 2111c discards raw data associated with the video of front side of each financial card and the video of backside of each financial card. The raw data associated with the video of front side of each financial card and the video of backside of each financial card may include video frame(s) that do not contribute to determine the financial card data. In this way, the financial data module 2111c determines the financial card data.

FIG. 2E illustrates operations 2000e associated with the verification module 2111d, in accordance with one or more example embodiments. The verification module 2111d verifies the identity of the user. Starting at block 2111d-0, the verification module 2111d verifies the facial data extracted from the facial data module 2111a with the facial data in the government identity card data. For instance, the verification module 2111d compares the facial data extracted at step 2111a-3 and the facial data in the government identity card data extracted at step 2111b-4 to verify whether both the facial data are same. In an embodiment, the verification module 2111d calculates an Euclidean distance across sixty eight facial landmarks between the facial data extracted at step 2111a-3 and the facial data extracted at step 2111b-4 and compares the Euclidean distance with a predefined threshold distance to verify whether both the facial data are same.

At block 2111d-1, the verification module 2111d verifies the name of the user in the financial card data with the name of the user in the government identity card data. For instance, the verification module 2111d compares the name of the user in the financial card data with the name of the user in the government identity card data to verify whether the name of the user in the government identity card data and the name of the user in the financial card data are same.

At block 2111d-2, the verification module 2111d verifies whether the user has the valid financial account. For instance, the verification module 2111d verifies whether the user has the valid financial account in bank(s) using the financial card data. In this way, the verification module 2111d verifies the identity of the user.

Referring to FIG. 2A, once the identity of the user is verified, the processor 2101 may be configured as the account creation module 2121. The account creation module 2121 creates an account for the user. In an embodiment, the account creation module 2121 creates the account to the user by requesting the user to provide user account information such as user email information (for instance, a unique email address). The email address may be a deterministic identifier, which is used to uniquely address the user. The email address may be further used as a point of contact by which the user can be kept informed of any important announcements or alerts related to the account. Further, the account creation module 2121 allows use of third-party OAuth (open-standard authorization protocol) providers, as the OAuth providers typically require an email address and a password to authenticate the user. Authenticated users are identifiable and traceable within the cloud server 2003, by means of a digital token, which is important as the cloud server 2003 records all transactions or connections in an immutable ledger database. In some embodiments, the cloud server 2003 comprises a Blockchain ledger database to record all transaction (including financial and non-financial transactions) and connections of the user. In some example embodiments, the cloud server 2003 may also store agreements recording rights transfer in the Blockchain ledger database.

OAuth is an open standard for access delegation, typically used by web APIs (Application Programming Interfaces) to authenticate the user without asking the user to enter the password. An example for creating the account using a third-party OAuth provider may include “Login with Amazon®”, “Login with Facebook®”, or the like. Once the user enters user credentials via LWA (Login with Amazon®) portal, a token valid for a predetermined time period is generated. Further, the token that is valid for the predetermined time period may be refreshed again by generating a refresh token. To that end, once the user has entered username and the password, the account creation module 2121 manages the token for the user such that the user may not be requested to enter the password again on subsequent sessions.

Further, the account creation module 2121 may provide the functionalities of an OAuth provider for other third-party applications or websites such that the user can login to the other third-party applications or websites by using an authentication process described herein.

The account creation module 2121 comprises an email validation module 2121a, a mobile validation module 2121b, a password module 2121c and a cryptographic key pair module 2121d for creating the account of the user. The email validation module 2121a receives, from the user, the user email information (i.e. the unique email address) as the user account information. Further, the email validation module 2121a sends, to the received email address, a confirmation link for an account registration. To that end, the email validation module 2121a verifies whether the received email address is valid or not and/or verifies ownership of the email address.

The mobile validation module 2121b requests the user to provide user communication information, for instance, a current mobile phone number of the user as the user account information, during the account creation process. Further, the mobile validation module 2121b sends, to the received mobile phone number, an SMS message with a unique code to be entered in a registration page to complete the account registration process. To that end, the mobile validation module 2121b verifies whether the received mobile phone number is valid or not and/or verifies ownership of the mobile phone number.

The password module 2121c receives, from the user, user password information as the user account information for creating the account to the user. The user password information may be a password generated by the user to create the account. Further, the received user password information is used as an input to the encryption module 2131 to encrypt the stored data in the memory 2201, which is further explained in the detail description of FIG. 2F. To that end, the data in the memory 2201 encrypted using the user password information is accessible only to the user. In an alternate embodiment, the password module 2121c receives user specific information to create the account for the user. The user specific information may include user's fingerprint data, user's facial data, user's device data (for instance, user's device data for generating OTP (One-Time Password)) and the like. Further, the use of user generated password as the input to the encryption module 2131 may be replaced by the user specific information to encrypt the data stored in the memory 2201.

The cryptographic key pair module 2121d generates a cryptographic key pair after the identity of the user is verified and the account for the user is created. Hereinafter, ‘cryptographic key pair’ and ‘digital token’ may be interchangeably used to mean the same. The cryptographic key pair includes one public key and one private key that are cryptographically related. Further, the cryptographic key pair is used as in Public Key Infrastructure (PKI) operations. In an embodiment, the cryptographic key pair is used to send encrypted messages between any number of users, such that only an intended recipient can decrypt the encrypted messages. For example, when a financial institution wants to send an encrypted message to a particular user, the financial institution encrypts the message with a public key of the particular user such that the particular user having the private key can only decrypt and read the message.

In an embodiment, the public key of the user is transmitted to the cloud server 2003 such that other users may reference the public key of the user, when the other users need the public key of the user for transmitting the messages securely to the user. Further, the public key may be used to verify a signature of the user. For instance, if the user is requested to submit an encrypted payload to another party, then the user can sign a payload with the private key of the user such that the another party may ensure the encrypted payload authenticity by verifying the signature with the public key of the user. In this way, the account creation module 2121 creates the account for the user and generates the cryptographic key pair for the user after the identity of the user is verified. Hereinafter, the account creation process of the account creation module 2121 and identity varication process of the identity verification module 2111 may be referred to as user on-boarding process.

Once the identity of the user is verified and the account is created, data extracted from the user on-boarding process is stored in the memory 2201 such that the extracted data may be used later for authenticating the user. In an embodiment, the memory 2201 comprises a user data module 2211, an encrypted user data module 2221, and an encryption key storage module 2231. The user data module 2211 stores the data extracted from the user on-boarding process. Hereinafter, ‘data extracted from the user on-boarding process’ and ‘first user data’ may be interchangeably used to mean the same. The data extracted from the user on-boarding process includes the user identity information and the user account information. The user identity information includes the facial data (i.e. the first facial data extracted at block 2111a-3), the government identity card data, and the financial card data. The user account information includes the user email information, the user communication information, the user password information, and the cryptographic key pair. In addition to storing the data extracted from the user on-boarding process, the user data module 2211 may also store a number of other sources of data, which are collected, analyzed, and continuously updated and refined over a time. To that end, the user data module 2211 stores behavioral data (also referred to as first behavioral data) of the user. The behavioral data includes GPS (Global Positioning System) location data (also referred to as first GPS location data), transaction data (also referred to as first transaction data), gait data (also referred to as first gait data), network data (also referred to as first network data), connection data (also referred to as first connection data), and the like. Accordingly, the user data module 2211 stores facial data 2211a, cryptographic key pair 2211b, connection data 2211c, network data 2211d, gait data 2211e, transaction data 2211f, GPS (Global Positioning System) location data 2211g, and user information data 2211h.

In an embodiment, a structure of the user data module 2211 is like JSON (JavaScript Object Notation) structure, as the JSON structure can be easily represented and manipulated across various mobile OS (Operating system) types and programming languages. Further, the JSON structure can also be easily outputted as a serial input to the encryption module 2131.

The facial data 2211a is the facial data extracted at block 2111a-3 of the facial data module 2111a. The facial data 2211a comprises the mapped face of the user using the sixty-eight points that makeup the user's facial landmark. The facial data 2211a may further comprise the mapped face of the user using the 3D point cloud of the 3D depth map, which may store up to one thousand points of user's facial profile, if the mobile device 2001 is equipped with 3D depth sensors. The facial data 2211a is referenced during the authentication process described herein for authenticating the user.

The cryptographic key pair 2211b is the cryptographic key pair generated in cryptographic key pair module 2121d. The cryptographic key pair 2211b comprises the private key and the public key that are cryptographically related. The public key is used to encrypt a message for securely sending the message to user from third parties. The private key is used to decrypt the encrypted message such that only the intended user can read the message. Further, the private key may also be used to sign payloads when payloads need to be signed by the user.

The connection data 2211c is a statistical representation of a connection graph of the user. The connection graph includes a unique list of digital tokens of other users with whom the user has performed transactions. The connection graph further includes a frequency indicating number times the user has transacted with each other user and temporal data indicating a time at which the user has transacted with each other user. The connection data 2211c is referenced during the authentication process described herein for authenticating the user.

The network data 2211d is a statistical model of network addresses (i.e. IP (Internet Protocol) address, Wi-Fi (Wireless Fidelity), SSID (Service Set Identifier), etc.). The network address includes frequent network addresses that the user uses to connect the mobile device 2001 to the cloud server 2003. The network data 2211d is a histogram of the frequent network addresses that the user uses to connect the mobile device 2001 to the cloud server 2003. The network data 2211d is referenced during the authentication process described herein for authenticating the user.

The gait data 2211e is a dynamic model of user's pattern of motion. In an embodiment, the gait data 2211e is continuously updated using an accelerometer sensor and/or a gyroscope sensor of the mobile device 2001. For instance, the accelerometer sensor and/or the gyroscope sensor continuously monitors various types of actions of the user such as walking, running, etc. as multiple correlated time series of data and updates the gait data 2211e. Further, the mobile device 2001 processes the multiple correlated time series of data for determining repeating cycles (i.e. steps). The determined repeating cycles may be used to uniquely identify the user. In an alternate embodiment, an accelerometer sensor and/or a gyroscope sensor of user's wearable devices (i.e. smart watches, fitness tracking devices, ear buds etc.) is used to update the gait data 2211e. The gait data 2211e is referenced during the authentication process described herein for authenticating the user.

The transaction data 2211f stores a statistical representation of a transaction history of the user. The transaction data 2211f includes an originating party, a type of a transaction, an estimate of a transaction amount (for financial transactions) and the like for each transaction performed by the user. The estimate of the transaction amount is recorded rather than recording an actual amount to avoid identifiability of the user. The estimate of transaction amount may be determined by a rounding function. For instance, $5.03 coffee purchase may be determined as <$10 transaction by the rounding function. Rounding thresholds used in the rounding function are selected such that abnormal purchases and fraudulent purchases are detected. Further, the rounding thresholds used in the rounding function are selected such that identity of the user cannot be identified by only obtaining the transaction data 2211f of the user. The transaction data 2211f is referenced during the authentication process described herein for authenticating the user.

The GPS location data 2211g is a statistical model of user's cumulative location history and user's recent location history. The GPS location data 2211g may be determined by position sensors of the mobile device 2001. The GPS location data 2211g is referenced during the authentication process described herein for authenticating the user.

The user information 2211h includes several user attributes. For instance, the user information 221h includes, but not limited to, the name of the user, the date of birth of the user, the user email information, the user connection information (i.e. the mobile phone number), the government identity card data, the financial card data and the like. The user information 2211h is referenced during a transaction process that requests a specific user attribute to complete the transaction process. For instance, when vendors request age attribute of the user for completing an age-restricted purchases, an entrance to bars, etc., the date of birth of the user is referenced to verify whether the age of the user is above a threshold age or not.

In this way, the user data module 2211 not only stores the data extracted from the user on-boarding process (i.e. the first user data) such as the facial data 2211a, the cryptographic key pair 2211b, the user information 2211h, and the like but also stores behavioral data of the user such as the connection data 2211c, the network data 2211d, the gait data 2211e, the transaction data 2211f, the GPS location data 2211g and the like. Therefore, the user data module 2211 stores all data pertaining to the identity of the user, which is highly sensitive. Accordingly, the data stored in the user data module 2211 should be securely stored in the memory 2201. Hereinafter, the data stored in the user data module 2211 that includes the data extracted from the user on-boarding process and the behavioral data of the user may be referred to as first data. To that end, the processor 2101 is configured as the encryption module 2131 to securely store the first data (i.e. the data stored in the user data module 2211) in encrypted user data module 2221. An encryption process of the encryption module 2131 is explained in the detailed description of FIG. 2F.

The storing of user data in the manner described above, in the user's mobile device 2001, provides enhanced safety and security for user data. Further, the verification of user's identity by using a combination of various techniques discussed above, like selfie video capture, government ID based verification, extraction and verification of 2D and 3D maps of user's face, combination of user's biometric data (like facial data) and behavioral data (like gait, network profile, transaction profile and the like) ensures high level security and improved theft and identity management for the user in various transactions requiring user identity verification. User's data is securely stored in user's mobile device 2001 and is not circulated to various third-party vendors, thus ensuring high level of data privacy, data protection, and data confidentiality, as compared to other user authentication solutions existing in the art. Further, encryption of user data by the encryption module 2131, before sending out data from user's mobile device 2001, adds another layer of security to the data.

FIG. 2F illustrates a block diagram 2000f of the encryption module 2131 for encrypting the data stored in the user data module 2211, in accordance with one or more example embodiments. In an embodiment, the encryption module 2131 encrypts the data stored in user data module 2211 to generate an encrypted data. Further, the encryption module 2131 stores the encrypted data in the encrypted user data module 2221. In an alternate embodiment, the encryption module 2131 generates the encrypted data and stores the generated encrypted data in the user data module 2211. For instance, once the encrypted data is generated, the encryption module 2131 may replace original data with the encrypted data in the user data module 2211.

The encryption module 2131 comprises a PBKDF2 (Password-Based Key Derivation Function 2) 2131a, an encryption key 2131b and an encryption algorithm 2131c for encrypting the data stored in the user data module 2211. The encryption key 2131b may be automatically generated random data. Further, the encryption key 2131b is stored in the encryption key storage module 2231 such that any other device may not access the encryption key 2131b to avoid a threat of exposure of the encryption key 2131b during network transfer to the other device. This further prevents data synchronization across multiple devices of the user, or the user cannot recover/restore user's own data on another device, as the encryption key 2131b is not accessible to another device. To that end, in an embodiment, the encryption key 2131b is created using the user specific information or using the user password information obtained from the password module 2121c. This allows the encryption key 2131b to be “re-created” on other devices. Accordingly, the user can recover/restore user's own data on another device, while the encryption key 2131b is securely stored in the encryption key storage module 2231 of the mobile device 2001. The encryption key 2131b is created from a KDF (key Derivation Function), for instance, the PBKDF2 2131a using the user specific information or using the user password information obtained from the password module 2121c. For instance, the user specific information or the user password information obtained from the password module 2121c is provided as an input to the PBKDF2 2131a and the PBKDF2 2131a creates the encryption key 2131b after performing a finite number hashing iteration. To that end, the PBKDF2 2131a ensures that only the user can access the encrypted data. Further, the PBKDF2 2131a increase time required for a brute force attack, as the encryption key 2131b is created after performing the finite number of hashing iterations. To that end, weak passwords (include passwords that are easy to “guess”) generated by the user during the account creation process is balanced by the finite number of hashing iterations in the PBKDF2 2131a.

Further, the encryption key 2131b and the data stored in the user data module 2211 is provided as an input to the encryption algorithm 2131c for encrypting the data stored in the user data module 2211. The encryption algorithm 2131c includes AES (Advanced Encryption Standard) algorithm, for instance, AES-256. The AES algorithm is a symmetric encryption algorithm. In other words, the AES algorithm uses same encryption key, for instance, the encryption key 2131b to encrypt and decrypt the data. The AES algorithm is a strong encryption algorithm which encrypts the data such that brute force attacks can be avoided. For instance, an attacker might take approximately 3*10⁵¹ years to identify the encryption key 2131b.

In this way, the encryption module 2131 encrypts the data stored on the user data module 2211 and stores the encrypted data on the encrypted user data module 2221 and/or the user data module 2211. Further, the stored encrypted data may be decrypted using the encryption key 2131b stored in the encryption key storage module 2231 during the authentication process described herein.

Additionally, the encrypted data may also be stored in the cloud sever 2003 for retrieving the data during sync operations between user devices owned by the user and/or user account restore/retrieval actions.

FIG. 2G illustrates a block diagram 2000g of the authentication module 2141 for authenticating the user, in accordance with one or more example embodiments. The authentication module 2141 authenticates the user to determine whether the user is a valid user or not. In other words, the authentication module 2141 authenticates a current user of the mobile device 2001 to determine whether the current user is the valid user of the account created during the account creation process or not for performing a transaction. As used herein, the current user may be the user who owns the mobile device 2001 or may be a different user who is trying to mimic/fake/replicate the user of the mobile device 2001. The authentication module 2141 obtains current data (also referred to as second data) as an input to authenticate the user. The current data includes current user data (also referred to as second user data) and current behavioral data (also referred to as second behavioral data). In an embodiment, the current user data is obtained from the current user of the mobile device 2001. The current user data includes current facial data 2143 (also referred to as second facial data), current password data (also referred to as second password data), current fingerprint data (also referred to as second fingerprint data) and the like. In an embodiment, the current behavioral data is determined by the mobile device 2001. The current behavioral data includes current GPS location data 2145 of the mobile device 2001 (also referred to as second GPS location data), current transaction data 2147 (also referred to as second transaction data), current gait data 2149 (also referred to as second gait data), current network data 2151 (also referred to as second network data) and the like.

In an embodiment, the authentication module 2141 comprises a facial confidence score module 2141a, a location confidence score module 2141b, a transaction confidence score module 2141c, a gait confidence score module 2141d, a network confidence score module 2141e, a confidence scores input module 2141f, and a confidence score evaluation module 2141g. The facial confidence score module 2141a comprises a liveness verification module 2141a-0, and a facial match determination module 2141a-1. In an embodiment, the liveness verification module 2141a-0 obtains the current facial data 2143 as input for verifying “liveness” of the user. The current facial data 2143 includes a set of facial landmarks (for instance, sixty-eight facial landmarks) extracted from a video comprising a face of the current user. Additionally, the current facial data 2143 includes 3D depth map of the face of the current user if the mobile device 2001 is equipped with the 3D depth sensors. Once liveness' of the current user is verified, the liveness verification module 2141a-0 forwards the current facial data 2143 to the facial match determination module 2141a-1.

The facial match determination module 2141a-1 obtains the facial data 2211a (i.e. the first facial data) after receiving the current facial data 2143 from the liveness verification module 2141a-0. The facial match determination module 2141a-1 determines whether the current facial data 2143 matches with the facial data 2211a. For instance, the facial match determination module 2141a-1 calculates an Euclidean distance across sixty eight facial landmarks between the facial data 2211a and the current facial data 2143 and compares the Euclidean distance to a predefined threshold distance to determine whether the current facial data 2143 matches with the facial data 2211a. The facial match determination module 2141a-1 determines a facial confidence score based on the facial match. As used herein, the facial confidence score is a value (for instance, a value between zero to one), which is determined by comparing the current facial data 2143 with the facial data 2211a. Further, the facial match determination module 2141a-1 forwards the facial confidence score to the confidence scores input module 2141f for further processing.

The location confidence score module 2141b obtains the current GPS location data 2145 and the current transaction data 2147 as an input. The current GPS location data 2145 includes a location (for instance, geographical coordinates) of the mobile device 2001. The current transaction data 2147 includes name of the transaction, current transaction location data (i.e. a location of a vendor with whom the user is performing the transaction), an estimate of transaction amount, name of a vendor with whom the user is performing the transaction, a digital identity of the vendor (if available) and the like. Further, the location confidence score module 2141b obtains the GPS location data 2211g after obtaining the current GPS location data 2145 and the current transaction data 2147 to determine a location confidence score. In an embodiment, the location confidence score module 2141b determines the location confidence score based on comparing the current GPS location data 2145 and the current transaction data with the GPS location data 2211g. As used herein, the location confidence score is a value (for instance, a value between zero to one), which is determined by comparing the current GPS location data 2145 and the current transaction data 2147 with the GPS location data 2211g.

The location confidence score module 2141b determines whether the user is performing a physical transaction, or the user is performing a remote transaction, based on the current GPS location data 2145 and the current transaction data 2147. Examples of physical transactions include a physical credit card purchase from a local merchant, a physical credit card purchase of medicine in pharmacies, etc. Remote transactions include transactions where the location of the user and the location of the vendor are different, for instance, an on-line purchase, and a transaction over phone, etc.

The location confidence score module 2141b may forward, to the confidence scores input module 2141f, a higher confidence score (for instance, a value close to one) as the location confidence score for further processing, if the user is performing the physical transaction. The location confidence score module 2141b may forward, to the confidence scores input module 2141f, a lower confidence score (for instance, a value close to zero) as the location confidence score for further processing, if the user is performing the remote transaction. Further, the lower confidence score is determined based on whether the user has initiated the remote transaction from a location where the user frequently visits (i.e. a location of user's home, a location of user's work station, etc.), and/or whether the user has initiated the remote transaction within a threshold distance from the location where the user frequently visits.

The transaction confidence score module 2141c obtains the current transaction data 2147 as an input. The current transaction data 2147 includes the name of the transaction, the current transaction location data (i.e. the location of the vendor with whom the user is performing the transaction), the estimate of the transaction amount, name of the vendor with whom the user is performing the transaction, the digital identity of the vendor (if available) and the like. Further, the transaction confidence score module 2141c obtains the transaction data 2211f and the connection data 2211c after obtaining the current transaction data 2147 to determine a location confidence score. In an embodiment, the transaction confidence score module 2141c determines the transaction confidence score based on comparing the current transaction data 2147 with the transaction data 2211f and the connection data 2211c. As used herein, the transaction confidence score is a value (for instance, a value between zero to one), which is determined by comparing the current transaction data 2147 with the transaction data 2211f and the connection data 2211c.

For example, the transaction confidence score module 2141c determines the transaction confidence score by comparing the name of the vendor in the current transaction data with existing connections, by analyzing the frequency of transactions made with the vendor, and/or by comparing the current estimate of the transaction amount with the previous estimates of transaction amount made with the vendor. The transaction confidence score module 2141c forwards the transaction confidence score to the confidence scores input module 2141f for further processing.

The gait confidence score module 2141d obtains the current gait data 2149 as an input. The current gait data incudes recent gait data of the user determined by the accelerometer sensor and/or the gyroscope sensor of the mobile device 2001 and/or recent gait data of the user determined by the accelerometer sensor and/or the gyroscope sensor of the user's wearable devices such as smart watches, fitness tracking devices, ear buds, etc. For instance, the recent gait data may be gait data generated, for example, ten minutes before the user initiated the transaction. The gait confidence score module 2141d obtain the gait data 2211e (i.e. the repeating cycles that uniquely identifies the user) after obtaining the current gait data 2149 to determine a gait confidence score. In an embodiment, the gait confidence score module 2141d determine the gait confidence score by comparing the current gait data 2149 with the gait data 2211e. As used herein, the gait confidence score is a value (for instance, a value between zero to one), which is determined by comparing the current gait data 2149 with the gait data 2211e. The gait confidence score module 2141d forwards the gait confidence score to the confidence scores input module 2141f for further processing.

The network confidence score module 2141e obtains the current network data 2151 as an input. The current network data 2151 includes the network address the user is using to connect the mobile device 2001 to cloud server 2003, while initiating the transaction. The network address may include several forms of addresses like global IP address, Wi-Fi, SSID, etc. depending on a communication medium (for instance, the network 1005), and/or underlying OS in the mobile device 2001. Further, the network confidence score module 2141e obtains the network data 2221d after obtaining the current network data 2151 to determine a network confidence score. In an embodiment, the network confidence score module 2141e determines the network confidence score based on comparing the current network data 2151 with the network data 2221d. As used herein, the network confidence score is a value (for instance, a value between zero to one), which is determined by comparing the current network data 2151 with the network data 2221d.

For instance, the network confidence score module 2141e may forward, to the confidence scores input module 2141f, a higher confidence score (for instance, a value close to one) as the network confidence score for further processing, if the user is using a network address that matches a frequently used network address in the network data 221d.

To that end, the authentication module 2141 determines a first plurality of confidence scores, for instance, the facial confidence score, the location confidence score, the transaction confidence score, the gait confidence score, and the network confidence score for authenticating the user. Here for the purpose of explanation, the first plurality of confidence scores comprising only five confidence scores (i.e. the facial confidence score, the location confidence score, the transaction confidence score, the gait confidence score, and the network confidence score) is considered. However, the first plurality of confidence scores may include more than five confidence scores without deviating from the scope of the invention. A confidence score in the first plurality of confidences scores may be mathematically represented as ‘xᵢ’, where, a notation ‘x’ indicates the confidence score and a notation T is a number from one (1) to ‘n’ (where ‘n’ is a positive integer).

Once the confidence scores input module 2141f receives the first plurality of confidence scores, the confidence scores input module 2141f triggers the confidence score evaluation module 2141g to determine a final confidence score (also referred to as a second confidence score), based on the first plurality of confidence scores.

FIG. 2H illustrates a block diagram 2000h of the confidence score evaluation module 2141g for determining a final confidence score 2141g-3, in accordance with one or more example embodiments. The confidence score evaluation module 2141g obtains the first plurality of confidence scores from the confidence scores input module 2141f The confidence score evaluation module 2141g determines a weight (mathematically represented as ‘wᵢ’, where ‘w’ is a weight) associated with each of the first plurality of confidence scores. For instance, the confidence score evaluation module 2141g determines a plurality of weights using a weigh determination module 2141g-0 for the first plurality of confidence scores. The plurality of weights comprises a weight ‘wᵢ’ for each confidence score ‘xᵢ’ in the first plurality of confidence scores. The weight ‘wᵢ’ may be determined based on experimentation and the like.

The confidence score evaluation module 2141g determines a second plurality of weighted confidence scores. The second plurality of weighted confidence scores comprises a weighted confidence score (mathematically represented as ‘wᵢxᵢ’) for each of the first plurality of confidence scores. In an embodiment, the weight confidence score ‘wᵢxᵢ’ is determined by multiplying a confidence score ‘xᵢ’ with its corresponding weight ‘wi’. The second plurality of weighted confidence scores is inputted into a summation function 2141g-1 to determine sum of products (which is mathematically represented as Σᵢ₌₁ⁿwᵢxᵢ) of the first plurality of confidence scores and the weight associated with each of the first plurality of confidence scores. Further, the output (i.e. Σᵢ₌₁ⁿwᵢxᵢ) of the summation function 2141g-1 is inputted into a sigmoid function 2141g-2. For instance, the sigmoid function 2141g-2 is a non-linear function that restricts an output value to be in range of zero (0) to one (1). The sigmoid function outputs the final confidence score 2141g-3 for authenticating the user. In an embodiment, the confidence score evaluation module 2141g determines whether the final confidence score 2141g-3 is greater than a threshold confidence score (e.g. a value of 0.8) for authenticating the user. Further, the confidence score evaluation module 2141g authenticates the user as the valid user if the final confidence score 2141g-3 is greater than the threshold confidence score. In some example embodiments, the threshold confidence score is a configurable value set by the user. In some other example embodiments, the threshold confidence score is a configurable value set by the mobile device 2001 depending upon a type of transaction. For instance, the mobile device 2001 may use a pre-trained machine learning model to determine the threshold confidence score depending upon the type of transaction.

In some example embodiments, the confidence score evaluation module 2141g does not consider all five first plurality of confidence scores to authenticate the user as the valid user. For instance, the determination of dynamic confidence scores such as the gait confidence score and the location confidence score may be time consuming, so the confidence score evaluation module 2141g may determine the final confidence score 2141g-3 based on passive confidence scores such as the transaction confidence score and/or the network confidence score. The passive confidence score is obtained on the basis of parameters that are passive, that is to say, that do not involve active user involvement, as against active parameters such as facial data of user, which require user involvement to capture the user's facial data. For example the data and/or parameters that are collected based on processes that run in the background, do not seek user interaction. Some of this data, such as user's network profile data, or data about their transactions are continuously monitored and collected by the background processes and stored in the user data module 2211. This may be particularly helpful and advantageous in scenarios that address challenges related to the notion of “user friction”.

“User fiction” may refer to the challenge pertaining to user behavior where the amount of effort/action required from the user to perform an action, such as user verification, is assessed. Thus, the less that the user must do “actively”, the less friction, and therefore more attractive for the user to use the system or application. So, in cases where confidence score is obtained based on “passive” data, the final confidence score 2141g-3 may be calculated without the need to request a facial recognition as part of the user verification process (such as if a user is located in/near their house, with the same IP address as their home router, and their gait activity is highly correlated, then we might not need a facial recognition verification as part of the transaction). This would allow a user to verify a transaction by simply touching a button (possibly even available on the lock screen of their mobile device 2001) rather than asking them to unlock the mobile device 2001, navigate to an application, such as the application executing the instructions stored in memory 2201, and take a selfie.

Thus after collecting confidence score associated with passive data, the mobile device 2001 may be configured to determine if the final confidence score 2141g-3 is greater than the threshold confidence score and avoid the determination of dynamic confidence scores, if the final confidence score 2141g-3 is greater than the threshold confidence score. To that end, the mobile device 2001 may authenticate the user using the authentication process provided herein efficiently in a reasonable amount time when the passive confidence scores are high enough to provide the final confidence score 2141g-3 that is greater than the threshold confidence score. Accordingly, the computation performed on the mobile device 2001 for authenticating the user may also be reduced, when the passive confidence scores are sufficient to authenticate the user.

In this way, the mobile device 2001 is configured to securely store the data of the user (i.e. the first data that pertains to the identity of the user) in the mobile device 2001 and further configured to authenticate the user, while performing the transaction such that an overhead of existing digital identity management systems is avoided without compromising to the data theft, data breach, and the like. The authentication process provided herein may be made available to an individual and/or a business unit by providing subscription schemes such as a business-to-business (B2B) subscription scheme and/or a business-to-client (B2C) subscription scheme. The authentication process provided herein is further explained with an exemplary business-to-business-to-consumer (B2B2C) working environment in detailed description of FIGS. 3A-3B.

FIG. 3A illustrates an exemplary working environment 3000a of a mobile device 3001 for authenticating the user while purchasing medicine in pharmacy, in accordance with one or more example embodiments. The working environment 3000a illustrates a scenario for authenticating the user while purchasing a medicine, for instance, pseudoephedrine-based product in a pharmacy 3007. Pseudoephedrine is a key ingredient in production of methamphetamines but is also commonly found in over the counter (OTC) products like Sudafed and Claritin-D. To curb methamphetamine production, monthly limits were imposed on sale of these OTC products to individuals. Currently, these monthly limits are enforced at a counter of the pharmacy 3007 by a combination of human inspection and electronic record keeping.

When requesting the pseudoephedrine-based product, the user (also referred to as a customer) is required to present a government issued ID card, for instance, a driving license. A pharmacy employee matches user's face with user's face in the government issued ID card and scans a barcode on the government issued ID card and a barcode on the requested pseudoephedrine-based product. Further, the scanned barcodes are sent to a third-party server such as a MethCheck® server 3005. The MethCheck® server 3005 performs a user lookup and monthly/daily limit threshold check. If preset threshold limit is not exceeded, then the MethCheck® server 3005 sends a response to the pharmacy 3007 to dispense the requested pseudoephedrine-based product to the user. Further, to complete the purchase, the user is required to sign a legal agreement indicating that the user understands attempts to defraud the process results in hefty fines and prison time.

Therefore, the data of the user (i.e. the government ID card which is sensitive information for the user) must be shared with multiple third parties to perform a simple threshold check. For instance, information encoded in the barcode is stored on pharmacy computer system and further shared with the MethCheck® server 3005 to perform a simple threshold check.

To that end, a mobile device 3001 is provided herein to authenticate the user such that the data of the user is not shared with third parties. The mobile device 3001 is the mobile device 2001 explained in the detailed description FIGS. 2A-2H.

The user begins the pseudoephedrine-based product purchase in the pharmacy 3007 by presenting at a step 3101, a loyalty card (for instance, a physical card or an electronic-card on the mobile device 3001) to the pharmacy employee. The loyalty card includes a barcode comprising a unique identity number that is unique to the user. Additionally, the barcode of the loyalty card may further comprise data about the user, for instance, name of the user, age of the user, and the like. In an embodiment, the unique identity number of the user, as contained in the barcode may be used to lookup the digital token (i.e. the cryptographic key pair) of the user from a backend database of the pharmacy 3007. The cryptographic key pair is then further used to initiate the process of authenticating the user for the product purchase transaction at the mobile device 3001 of the user. To that end, the user on-boarding process of the user explained in the detailed description of FIGS. 2A-2F is already completed before presenting the loyalty card.

The pharmacy employee scans the barcode in the loyalty card, to lookup the digital token of the user. Further, the pharmacy employee also scans the barcode on the requested pseudoephedrine-based product. Scanned barcodes information is sent, at step 3103, to the MethCheck® server 3005. The MethCheck® server 3005 stores the scanned barcodes information. Further, the MethCheck® server 3005 generates a transaction request, at step 3105, (also referred to as an authentication request) comprising the digital token of the user and pseudoephedrine-based product information and transmits the transaction request 3105 to the cloud server 3003 for initiating a handshake between the MethCheck® server 3005 and cloud server 3003. The cloud server 3003 is the cloud server 2003 explained in the detailed of FIG. 2A. The cloud server 3003 receives the transaction request 3105 from the MethCheck® server 3005. The cloud server 3003 records the transaction request 3105 in the immutable ledger database. The cloud server 3003 generates a push notification 3107 (also referred to as an authentication response) using the digital token of the user and transmits the push notification 3107 to the mobile device 3001 for authenticating the user. The push notification 3107 comprises the pseudoephedrine-based product information. Additionally, the push notification 3107 includes pharmacy address and the like.

The mobile device 3001 receives the push notification 3107 from the cloud server 3003. The mobile device 3001 displays a confirmation user interface to the user based on the received the push notification 3107. For instance, a confirmation screen is displayed to the user with the pseudoephedrine-based product information. The user confirms the pseudoephedrine-based product purchase by taking a selfie or a selfie video (i.e. the second facial data). To that end, the mobile device 3001 authenticates the user only after receiving the user's confirmation. In other words, the mobile device 3001 may not authenticate the user or share the data of the user without permission of the user.

Further, the mobile device 3001 authenticates the user after receiving the user's confirmation, based on the current data (i.e. the second facial data and the second behavioral data) and the data stored in the user data module 2211 (i.e. the first facial data and the first behavioral data) as explained in the detailed description of FIG. 2G and FIG. 2H. Additionally or alternatively, once the mobile device 3001 authenticates the user as the valid user, the mobile device 3001 displays, to the user, a screen with a signature screen comprising requisite legal agreement for recording a user's signature.

Further, the mobile device 3001 encrypts the user's signature with a public key of the pharmacy 3007 such that the pharmacy 3007 may decrypt the user's signature using a private of the pharmacy 3007. The mobile device 3001 transmits, to the cloud server 3003, a response 3109 comprising transaction confirmation information (i.e. information indicating the user is the valid user and the user accepts the pseudoephedrine-based product purchase) and the encrypted user's signature (if available). The cloud server 3003 receives the response 3109 from the mobile device 3001. The cloud server 3003 stores the transaction confirmation information in the immutable ledger database and stores the encrypted user's signature in a blob database. Further, the cloud server 3003 generates and transmits a transaction response 3111 to the MethCheck® server 3005 for terminating the handshake between the MethCheck® server 3005 and the cloud server 3003. The transaction response 3111 comprises the transaction confirmation information. In some example embodiments, the handshake process between the MethCheck® server 3005 and cloud server 3003 may be performed securely using at least one encryption algorithm know in the art.

The MethCheck® 3005 receives the transaction response 3111 and checks a dosage of the requested pseudoephedrine-based product against an internal database of the MethCheck® server 3005 to determine if the dosage of the requested pseudoephedrine-based product is exceeding the monthly/daily limit threshold. The MethCheck® server 3005 generates and transmits, to the pharmacy 3007, a response 3113 to dispense the requested pseudoephedrine-based product to the user, if the dosage of the requested pseudoephedrine-based product is not exceeding the monthly/daily limit threshold. The pharmacy 3007 dispenses the pseudoephedrine-based product, at step, 3115 to the user.

In this way, the mobile device 3001 eliminates a physical exchange of the user's government issued identity card that contains sensitive information of the user with a robust user on-boarding process and a robust authentication process provided herein. In other words, the authentication process provided herein replaces the physical exchange of the user's government issued identity card with the handshake process for authenticating the user without using the data of the user (i.e. the government identity card data) in the handshake process. To that end, the mobile device 3001 is configured to securely store the data extracted from the user on-boarding process in the mobile device 3001 owned by the user and authenticate the user such that an overhead of MethCheck® server 3005 and the pharmacy 3007 to maintain the sensitive information of the user is avoided without compromising to the data theft and data breach and the like. Further, the mobile device 2001 reduces a burden and a reliance on an implicit facial recognition function performed by the pharmacy employee.

FIG. 3B illustrates an exemplary working environment 3000b of the mobile device 3001 for authenticating the user while purchasing medicine in pharmacy, in accordance with one or more example embodiments. The working environment 3000b illustrates a scenario for authenticating the user while purchasing the OTC products such as the pseudoephedrine-based product in the pharmacy 3007. The user begins the pseudoephedrine-based product purchase in the pharmacy 3007 by presenting a loyalty card, at step3301, to the pharmacy employee. The loyalty card is the loyalty card explained in the detailed description of FIG. 3A. The pharmacy 3007 transmits scanned barcodes information, at step 3303, to the cloud server 3003. The scanned barcodes information is the scanned barcodes information 3103 explained in the detailed description of FIG. 3A. The cloud server 3003 receives and stores the scanned barcodes information. The cloud server 3003 generates and transmits a push notification 3305 to the mobile device 3001. The push notification 3305 is the push notification 3107 explained in the detailed description of FIG. 3A. The mobile device 3001 receives the push notification 3305 from the cloud server 3003. The mobile device 3001 displays the confirmation user interface to the user based on the received the push notification 3305. For instance, a confirmation screen is displayed to the user with the pseudoephedrine-based product information. The user confirms the pseudoephedrine-based product purchase by taking a selfie or a selfie video (i.e. the second facial data). The mobile device 3001 authenticates the user based on the current data (i.e. the second facial data and the second behavioral data) and the data stored in the user data module 2211 (i.e. the first facial data and the first behavioral data) as explained in the detailed description of FIG. 2G and FIG. 2H. Additionally or alternatively, once the mobile device 3001 authenticates the user as the valid user, the mobile device 3001 displays, to the user, the screen with the signature screen comprising requisite legal agreement and records the user's signature.

Further, the mobile device 3001 encrypts the user's signature with the public key of the pharmacy 3007 such that the pharmacy 3007 may decrypt the user's signature using the private of the pharmacy 3007. The mobile device 3001 transmits a response 3307 to the cloud server 3003. The response 3307 is the response 3109 explained in the detailed description of FIG. 3A. The cloud server 3003 receives the response 3307 and checks the dosage of the requested pseudoephedrine-based product against the immutable ledger database to determine if the dosage of the requested pseudoephedrine-based product is exceeding the monthly/daily limit threshold. The cloud server 3003 generates and transmits, to the pharmacy 3007, a response 3309 to dispense the requested pseudoephedrine-based product to the user. The pharmacy 3007 dispenses the pseudoephedrine-based product 3115 to the user.

In this way, the cloud server 3003 may also be configured to perform the functionalities performed by the MethCheck® server 3005. To that end, the third party such as the MethCheck® sever 3005 for performing the monthly/daily limit threshold check of a dosage limit of the pseudoephedrine-based product may be by passed.

FIG. 4 illustrates an exemplary working environment 4000 of a mobile device 4001 for authenticating the user while performing a financial transaction, in accordance with one or more example embodiments. The working environment 4000 illustrates a scenario for authenticating the user while performing a financial transaction during a peer payment, a retail purchase, or an on-line transaction. For instance, a mobile peer 4007 involved in the peer payment, a POS (Point of Sale) vendor 4009 involved in the retail purchase, or an online retailer 4011 involved in the online transaction begins the financial transaction by sending, to a financial institution server 4005, an authorization request 4101 comprising a transaction amount. The financial institution server 4005 receives the authorization request 4101 and transmits, to the cloud server 4003, an authentication request 4103 for authenticating the user. The financial institution server 4005 includes a server or a group of servers of a bank that provides a financial service. The authentication request 4103 comprises the transaction amount and information about a recipient. For instance, the receipt includes a user of the mobile peer 4007, the POS vendor 4009, and/or the online retailer 4011.

The cloud server 4003 receives the authentication request 4103 from the financial institution server 4005. The cloud server 4003 is the cloud server 2003 explained in the detailed description of FIG. 2. The cloud server 4003 sends, to the mobile device 4001, a push notification 4105 (also referred to as the authentication response) for authenticating the user. The push notification 4105 comprises the transaction amount and the information about the recipient.

The mobile device 4001 receives the push notification 4105 from the cloud server 4003. The mobile device 4001 is the mobile device 2001 explained in the detailed description of FIG. 2. The mobile device 4001 displays a confirmation user interface to the user based on the received the push notification 4105. For instance, a confirmation screen is displayed to the user with the transaction amount and the information about the recipient. The user confirms the financial transaction by taking a selfie or a video (i.e. the second facial data). The mobile device 4001 authenticates the user based on the current data (i.e. the second facial data and the second behavioral data) and the data stored in the user data module 2211 (i.e. the first facial data and the first behavioral data) as explained in the detailed description of FIG. 2G and FIG. 2H.

The mobile device 4001 transmits, to the cloud server 4003, a response 4107, if the user is the valid user. The response 4107 comprises transaction confirmation information (i.e. information indicating the user is the valid user and the user accepts the financial transaction). The cloud server 4003 receives the response 4107 from the mobile device 4001 and stores the response 4107 in the immutable ledger database. The cloud server 4003 transmits a confirmation response 4109 to the financial institution server 4005 in response to receiving the response 4107. The financial institution server 4005 confirms the financial transaction by transferring the requested transaction amount to the receipt (i.e. the user of the mobile peer 4007, the POS vendor 4009, and/or the online retailer 4011).

In this way, the mobile device 4001 is configured to authenticate the user while performing the financial transaction such that an overhead of the financial institution server 4005 to maintain user information and to authenticate the user are avoided without compromising to the data theft and the data breach and the like.

FIG. 5 illustrates a block diagram 5000 of the cloud server 4003 exemplarily illustrated in FIG. 4, in accordance with one or more example embodiments. As illustrated in FIG. 5, the block diagram 5000 comprises a mobile device 5001, a cloud server 5003, and a financial institution server 5005. The mobile device 5001 is the mobile device 4001 explained in the detailed description of FIG. 4. The cloud server 5003 is the cloud server 4003 explained in the detailed description of FIG. 4. The financial institution server 5005 is the financial institution server 4005 explained in the detailed description of FIG. 4.

The cloud server 5003 comprises a cloud server web API 5003a, a cloud server business logic 5003b, a user database 5003c, and a push notification service 5003d. The cloud server receives an authentication request 5101 for authenticating the user. The authentication request 5101 is the authentication request 4103 explained in the detailed description of FIG. 4. To that end, the authentication request 5101 comprises the transaction amount and the information about the recipient.

For instance, the cloud server web API 5003a of the cloud server 5003 receives the authentication request 5101. The cloud server WEB API 5003a authenticates the financial institution server 5005 via OAuth (open-standard authorization protocol). Once authenticated, the cloud server web API 5003a routes the authentication request 5101 as a web request 5103 to the cloud server business logic 5003b. The cloud server business logic 5003b receives the web request 5103 from the cloud server web API 5003a. The cloud server business logic 5003b uses appropriate business logic (for instance, a financial transaction logic) and the user database 5003c to map the user to a digital token 5105 of the user. The cloud server business logic 5003b transmits push notification information 5107 to the push notification service 5003d. The push notification information 5107 comprises the transaction amount, the information about the recipient, and the digital token 5105. The push notification service 50003d transmits, to the mobile device 5001, a push notification 5109 for authenticating the user using a destination notification service (for instance, iOS, Android, or the like). The push notification 5109 is the push notification 4105 explained in the detailed description of FIG. 4. To that end, the push notification 5109 comprises the transaction amount and the information about the recipient.

The mobile device 5001 displays a confirmation user interface 5111 to the user based on the push notification 5109. The user confirms the financial transaction by taking a selfie or a selfie video (i.e. the second facial data). The mobile device 4001 authenticates the user based on the current data (i.e. the second facial data and the second behavioral data) and the data stored in the user data module 2211 (i.e. the first facial data and the first behavioral data) as explained in the detailed description of FIG. 2G and FIG. 2H.

The mobile device 5001 sends a response 5113 to the cloud server business logic 5003b. The response 5113 is the response 4107 explained in the detailed description of FIG. 4. To that end, the response 5113 comprises the transaction confirmation information (i.e. information indicating the user is the valid user and the user accepts the financial transaction). The cloud server business logic 5003b receives the response 5113 from the mobile device 5001. The cloud server business logic 5003b transmits a confirmation response 5115 to the financial institution server 5005, in response to receiving the response 5113. Further, the financial institution server 5005 confirms the financial transaction as explained in the detailed description of FIG. 4.

In this way, the cloud server 5003 is configured to receive, from the financial institution server 5005, the authentication request 5101 and transmits, to the financial institution server 5005, the confirmation response 5115.

FIG. 6 illustrates an exemplary working environment 6000 of a mobile device 6001 for authenticating the user in ride share application, in accordance with one or more example embodiments. A rider (i.e. the user) requests, using a rider's mobile device 6001, a ride pickup 6101 from a ride share application server 6007. The ride shares application server 6007 is a server of a ride sharing application, such as ‘Uber®’ application, a server of a ‘Lyft®’ application, and the like.

The ride sharing application server 6007 sends a pickup request 6103 to a driver's mobile device 6005. The driver's mobile device 6005 receives the pickup request 6103 from the ride sharing application server 6007. A driver sends, using the driver's mobile device 6005, a driver's confirmation 6105 to the ride sharing application server 6007, in response to receiving the pickup request 6103. The driver's mobile device 6005 sends driver's information message 6107 to the cloud server 6003. In an embodiment, the driver's information message 6107 is encrypted with a public key of the rider such that only the rider can decrypt the encrypted driver's information message using a private key of the rider and access the driver's information message 6107.

The cloud server 6003 receives the driver's information message 6107 from the driver's mobile device 6005. The cloud server 6003 is the cloud server 2003 explained in the detailed description of FIG. 2. The cloud server 6003 sends a push notification 6109 (also referred to the authentication response) comprising the driver's information message 6107 to the rider's mobile device 6001.

The rider's mobile device 6001 receives the push notification 6109 from the cloud server 6003. The rider's mobile device 6001 displays the driver's information message 6107 to the rider for a rider's confirmation. The rider's mobile device 6001 sends, to the cloud server 6003, a rider's information message 6111, if the rider confirms the ride. To that end, the rider's mobile device 6001 authenticates the user and the sends the rider's information message 6111 only after receiving the rider's confirmation. In other words, the rider's mobile device 6001 may not authenticate the user and/or share the data of the rider without permission of the rider. In an embodiment, the rider's information message 6111 is encrypted with a public key of the driver such that only the driver can decrypt the encrypted rider's information message using a private key of the driver and access the rider's information message 6111.

The cloud server 6003 receives the rider's information message 6111 from the rider's mobile device 6001. The cloud server 6003 sends, to the driver's mobile device 6005, a rider response 6113 comprising the rider's information message 6111 and the rider's confirmation. Once the driver's mobile device 6005 receives the rider response 6113, the ride application server 6007 confirm the ride.

In this way, the mobile device 6001 is configured to securely store rider's information in the rider's mobile device 6005 and driver's information in the driver's mobile device 6005 while using the ride share application. Further, the mobile device 6001 authenticates the driver while sending the driver's information message 6107 and authenticates the rider while sending the rider's information message 6111. Accordingly, the mobile device 6001 provided herein avoids an overhead of the ride share application server 6007 to maintain rider's information and driver's information without comprising to the data theft and data breach and the like.

FIG. 7 illustrates a block diagram 7000 of the driver's mobile device 6005 exemplarily illustrated in FIG. 6 during diver's work session initiation, in accordance with one or more example embodiments. The driver's mobile device 7001 is the driver's mobile device 6005 explained in the detailed description of FIG. 6. The driver's mobile device 7001 comprises at least two executable-software applications, for instance, a ride shares software 7001a and an authentication software 7001b. The ride share software 7001a is the ‘Uber®’ application, the ‘Lyft®’ application, or the like. The authentication software 7001b includes the computer-executable instructions provided herein for authenticating the user. Further, the driver's mobile device 7001 comprises an interface 7001c between the ride share software 7001a and the authentication software 7001b for invoking the authentication process described herein.

The ride share software 7001a comprises a driver session initiation module 7001a-0, and an authentication software library 7001a-1. The driver session initiation module 7001a-0 provides the driver a “login-in” option to initiate a driver's work session or to initiate a driver's specific shift. The authentication software library 7001a-1 is an SDK (Software Development Kit) of the authentication software 7001b, which is integrated into the ride share software 7001a for transmitting requests to the authentication software 7001b. Once the driver, using the driver session initiation module 7001a-0, initiates the driver's work session, the authentication software library 7001a-1 transmits, to the authentication software 7001b, a request for authenticating the driver via the interface 7001c.

The authentication software 7001b receives, from the authentication software library 7001a-1, the request for authenticating the driver. The authentication software 70001b comprises an authentication module 7001b-0, a third-party API 7001b-1, an encrypted driver data module 7001b-2. The authentication module 7001b-0 is the authentication module 2141 explained in the detailed description of FIG. 2G and FIG. 2H. The encrypted user data module 7001b-2 is the encrypted user data module 2221 explained in the detailed description of FIG. 2F.

For instance, the third-party API 7001b-1 of the authentication software 7001b receives, from the authentication software library 7001a-1, the request for authenticating the driver. Once the third-party API 7001b-1 receives the request for authenticating the driver, the authentication module 7001b-0 provides, to the driver, an authentication screen for obtaining the current facial data. Further, the authentication module 70001b-0 authenticates the driver as explained in the detailed description of FIG. 2G and FIG. 2H. The current facial data is securely stored in the encrypted user data module 2221, until the pickup request is received from the rider via the ride sharing application server 6007.

FIG. 8 illustrates a block diagram 8000 of a driver's mobile device 6005 exemplarily illustrated in FIG. 6 after receiving the pickup request, in accordance with one or more example embodiments. The driver's mobile device 8001 is the driver's mobile device 6005 explained in the detailed description of FIG. 6 after receiving the pickup request from the rider. The driver's mobile device 8001 comprises a ride share software 8001a and an authentication software 8001b. The ride share software 8001a is the ride share software 7001a explained in the detailed description of FIG. 7. The authentication software 8001b is the authentication software 7001b explained in the detailed description of FIG. 7.

The ride share software 8001a comprises a pickup request reception module 8001a-0, a ride confirmation module 8001a-1 and an authentication software library 8001a-2. The pickup request reception module 8001a-0 receives a pickup request 8101. The pickup request 8101 is the pickup request 6103 explained in the detailed description of FIG. 6. The pickup request reception module 8001a-0 sends the pickup request 8101 to the ride confirmation module 8001a-1. The driver, using the ride confirmation module 8001a-1, confirms the ride. The ride confirmation module 8001a-1 sends a ride confirmation 8103 to the authentication software library 8001a-2. The authentication software library 8001a-2 is the authentication software library 7001a-1 explained in the detailed description of FIG. 7.

The authentication software library 8001a-2 receives the ride confirmation 8103 from the ride confirmation module 8001a-1. The authentication software library 8001a-2 sends, to the authentication software 8001b, a request 8105 for sending driver's information message. The authentication software 8001b comprises a ride share logic 8001b-0, a third-party API 8001b-1, and an encrypted user data module 8001b-2.

For instance, the third-party API 8001b-1 of the authentication software receives the request 8105 for sending the driver's information message. The third-party API 8001b-1 obtains encrypted driver's information message 8107 from the encrypted user data module 8001b-2. Further, the third part API 8001b-1 decrypts the encrypted driver's information message and sends driver's information message 8109 to the ride share logic 8001b-0. The ride share logic 8001b-0 encrypts the driver's information message 8109 using the public key of the rider. The rider share logic 8001b-0 sends, to the cloud server 6003, the driver's information message 8111 encrypted using the public key of the rider. The driver's information message 8111 encrypted using the public key of the rider is the driver's information message 6107 explained in the detailed description of FIG. 6.

Further, the ride share logic 8001b-0 receives, from the cloud server 6003, a rider response 8113 comprising rider's information message encrypted with the public key of the driver. The rider response 8113 comprising the rider's information message encrypted with the public key of the driver is the rider response 6113 explained in the detailed description of the FIG. 6. The rider share logic 8001b-0 decrypts, using the private key of the driver, the ride response 8113 comprising rider's information message encrypted with the public key of the driver. The rider share logic 8001b-0 sends rider information message 8115 to the third-party API 8001b-1. The third-party API 8001b-1 sends, to the authentication software library 8001a-2, a response 8117 comprising the rider's information message and the rider confirmation.

In this way, the driver's mobile device 8001 configured to securely transmit, to the cloud server 6003, the driver's information stored in the driver's mobile device 8001 and securely receive, from the cloud server 6003, the rider's information stored in the rider's mobile device 6001.

FIG. 9 illustrates a block diagram 9000 of the cloud server 6003 exemplarily illustrated in FIG. 6, in accordance with one or more example embodiments. As illustrated in FIG. 9, the block diagram 9000 comprises a rider's mobile device 9001, a cloud server 9003, and a driver's mobile device 9005. The rider's mobile device 9001 is the rider's mobile device 6001 explained in the detailed description of FIG. 6. The cloud server 9003 is the cloud server 6003 explained in the detailed description of FIG. 6. The driver's mobile device 9005 is the driver's mobile device 6005 explained in the detailed description of FIG. 6.

The cloud server 9003 comprises a cloud server web API 9003a, a cloud server business logic 9003b, a user database 9003c, a blob database 9003d, a ledger database 9003e, and a push notification service 9003f. The cloud server web API 9003 a receives driver's information message 9101 encrypted with the public key of the rider from the driver's mobile device 9005. The driver's information message 9101 is the driver's information message 6107 explained in detailed description of FIG. 6. The cloud server web API 9003a sends, to the cloud server business logic 9003b, a driver's confirmation request 9103 for processing. The driver's confirmation request 9103 comprises driver's information message 9101 encrypted with the public key of the rider. The cloud server business logic 9003b receives the driver's confirmation request 9103 from the cloud server web API 9003a. The cloud server business logic 9003b uses appropriate business logic (for instance, a ride shares logic) and the user database 9003c to determine a digital token 9105 of the rider. The cloud server business logic 9003b stores the driver's information message 9101 encrypted with the public key of the rider as an encrypted driver's data blob 9107 in the blob database 9003d. The cloud server business logic 9003b stores a driver's confirmation 9109 in the ledger database 9003e (for instance, an immutable ledger database), in response to receiving the driver's confirmation request 9103.

The cloud server business logic transmits push notification information 9111 to the push notification service 9003f The push notification information 9111 comprises the digital identity 9105 and the driver's information message 9101 encrypted with the public key of the rider. The push notification service 9003f transmits a push notification 9113 to the rider's mobile device 9001. The push notification 9113 is the push notification 6109 explained in the detailed description of FIG. 6. The push notification 9113 comprises the driver's data 9101 encrypted with the public key of the rider. The rider's mobile device 9001 decrypts, using the private key of the rider, the driver's information message 9101 encrypted with the public key of the rider. The rider's mobile device 9001 displays a confirmation screen 9115 for sending rider's information message. The confirmation screen 9115 comprises the decrypted driver's information message. Once the rider confirms the ride by taking a selfie or a selfie video, the rider's mobile device 9001 authenticates the rider as explained in the detailed description of FIG. 2G and FIG. 2H.

The rider's mobile device 9001 send, to the cloud server 9003, rider' information message 9117 encrypted with the public key of the driver. The rider's information message 9117 is the rider's information message 6111 explained in the detailed description of FIG. 6. The cloud server business logic 9003b of the cloud server receives the rider' information message 9117 encrypted with the public key of the driver. The cloud server business logic 9003b sends, to the driver's mobile device 9005, a rider response 9119 in response to receiving the rider' data 9117. The rider response 9119 comprises the rider's confirmation and the rider information message 9117 encrypted with the public key of the driver. The rider response 9119 is the rider response 6113 explained in the detailed description of FIG. 6.

In this way, the cloud server 9003 is configured to receive, from the driver's mobile device 9005, the driver's information message 9101 and transmit, to the rider's mobile device 9001, the push notification 9113. Further, cloud server 9003 is configured to receive, from the rider's mobile device 9001, the rider's information message 9117 and transmit, to the driver's mobile device 9005, the rider response 9119.

FIG. 10A illustrates a flowchart of a method for authenticating the user, in accordance with one or more example embodiments. It will be understood that each block of the flow diagram of the method 10000 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 2201 of the mobile device 2001, employing an embodiment of the present invention and executed by the processor 2101. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Starting at block 10001, the method 10000 includes storing data of the user. For instance, the mobile device 2001, using the identity verification module 2111 and the account creation module 2121, determines and stores the data of the user (i.e. the first data). The data of the user includes the user data (i.e. the first user data) and the behavioral data of the user (i.e. the first behavioral data). The user data includes the facial data 2211a and the user information 2211h. The behavioral data includes the connection data 2211c, the network data 2211d, the gait data 2211e, the transaction data 2211f, and the GPS location data 2211g.

At block 10003, the method 10000 includes receiving, from the cloud server 2003, a push notification (i.e. the authentication response) for authenticating the user. For instance, the mobile device 2001 receives, from the cloud server 2003, the push notification for authenticating the user.

At block 10005, the method 10000 incudes determining the current data (i.e. the second data) based on the received push notification. For instance, the mobile device 2001 determines the current data, if the user accepts the push notification. The current data includes the current user data (i.e. the second user data) and the current behavioral data (i.e. the second behavioral data). The current user data includes the current facial data 2143. The current behavioral data includes the current GPS location data 2145, the current transaction data 2147, the current gait data 2149, and the current network data 2151.

At block 10007, the method 10000 includes determining a first plurality of confidence scores, based on the first comparison of the current data and the data of the user. For instance, the mobile device 2001 determines the first plurality of confidence scores as explained in the detailed description of FIG. 2G. The block 10007 comprises a series of steps or operations for determining the first plurality of confidence scores, which are explained in the detailed description of FIG. 10B.

FIG. 10B illustrates a flowchart of the block 10007 for determining the first plurality of confidence scores, in accordance with one or more example embodiments. Starting at block 10007a, the block 10007 includes determining the facial confidence score based on comparing the current facial data 2143 and the facial data 2211a. For instance, the mobile device 2001 determines the facial confidence score, using the facial confidence score module 2141a, based on comparing the current facial data 2143 and the facial data 2211a as explained in the detailed description of FIG. 2G.

At block 10007b, the block 10007 includes determining the location confidence score based on comparing the current GPS location data 2145 and/or the current transaction data 2147 with the GPS location data 2211g. For instance, the mobile device 2001 determines the location confidence score, using the location confidence score module 2141b, based on comparing the current GPS location data 2145 and/or the current transaction data with the GPS location data 2211g as explained in the detailed description of FIG. 2G.

At block 10007c, the block 10007 includes determining the gait confidence score based on comparing the current gait data 2149 with the gait data 2211e. For instance, the mobile device 2001 determines the gait confidence score, using the gait confidence score module 2142d, based on comparing the current gait data 2149 with the gait data 2211e as explained in the detailed description of FIG. 2G.

At block 10007d, the block 10007 includes determining the transaction confidence score based on comparing the current transaction data 2147 with the transaction data 2211f and the connection data 2211c. For instance, the mobile device 2001 determines the transaction confidence score, using the transaction confidence score module 2141c, based on comparing the current transaction data 2147 with the transaction data 2211f and the connection data 2211c as explained in the detailed description of FIG. 2G.

At block 10007e, the block 1007 includes determining the network confidence score based on comparing the current network data 2151 with the network data 2211d. For instance, the mobile device 2001 determines the network confidence score, using the network confidence score module 2141e, based on comparing the current network data 2151 with the network data 2211d as explained in the detailed description of FIG. 2G.

As should be understood, once two or more blocks (10007a-10007e) of the block 10007 is executed by the mobile device 2001, the mobile device 2001 continues with block 10009.

At block 10009, the method 10000 includes determining the final confidence score 2141g-3 (i.e. the second confidence score) based on the first plurality of confidence scores. For instance, the mobile device 2001 determines the final confidence score 2141g-3, using the confidence score evaluation module 2141g, based on the first plurality of confidence scores as explained in the detailed description of FIG. 2H. The block 10009 comprises a series of steps or operations for determining the final confidence score 2141g-3, which are explained in the detailed description of FIG. 10C.

FIG. 10C illustrates a flowchart of the block 10009 for determining the final confidence score 2141g-3, in accordance with one or more example embodiments. Starting at block 10009a, the block 10009 includes determining a weighted associated with each of the first plurality of the confidence scores. For instance, the mobile device 2001 determines the plurality of weights 2141g-0 for the first plurality of confidence scores as explained in the detailed description of FIG. 2H.

At block 10009b, the block 10009 includes determining the second plurality of weighted confidence scores. For instance, the mobile device 2001 determines the second plurality of confidence scores as explained in the detailed description of FIG. 2H. The second plurality of weighted confidence scores comprises the weighted confidence score for each of the first plurality of confidence scores. The weighted confidence score for each of the first plurality of confidence scores is obtained by multiplying a respective weight associated with each of the first plurality of confidence scores with the respective confidence score of the first plurality of confidence scores.

At block 10009c, the block 10009 includes determining the final confidence score 2141g-3 based on a function of the determined second plurality of weighted confidence scores. For instance, the mobile device 2001 determines the final confidence score 2141g-3 based on the function of the determined second plurality of weighted confidence scores as explained in the detailed description of FIG. 2H. The function is at least one of the summation function 2141g-1 and the sigmoid function 2141g-2.

As should be understood, once each of the blocks (10009a-10009c) of the block 10009 is executed by the mobile device 2001, the mobile device 2001 continues with block 10011.

At block 10011, the method 10000 includes authenticating the user based on the final confidence score 2141g-3. For instance, the mobile device 2001 authenticates the user, based on the second comparison of the final confidence score 2141g-3 with the threshold confidence score. Further, the mobile device 2001 authenticates the user as the valid user, if the second confidence score is greater than the threshold confidence score.

In this way, the mobile device 2001 is configured to securely store the data of the user (i.e. the first data) in the mobile device 2001 and further configured to authenticate the user, when the mobile device 2001 executes the method 10000 such that an overhead of existing digital identity management systems is avoided without compromising to the data theft, data breach, and the like.

FIG. 11 illustrates a flowchart of a method 11000 for on boarding the user, in accordance with one or more example embodiments. The method 11000 may be used in conjunction with mobile device 2001 described in the detail description of FIGS. 2A-2H. Although various steps of method 11000 are described below and depicted in FIG. 11, the steps need not necessarily all be performed, and in some cases may be performed in a different order than the order shown.

Starting at block 11001, the method 11001 includes obtaining, from the user, the user account information and the user identity information. For instance, the processor 2101 of the mobile device 2001 is configured as the identity verification module 2111 for obtaining the user identity data and configured as the account creation module 2121 for obtaining the user account information. The user account information comprises at least the user email information, the user communication information and the user password information. The user identity information comprises at least the user image data (i.e. the first facial data), user financial data (i.e. the financial card data), and the user government identity data (i.e. the government identity card data).

At block 11003, the method 11000 includes verifying the identity of the user based on the obtained user identity information. For instance, the processor 2101 of the mobile device 2001 is configured as the identity verification module 2111 for verifying the identity of the user, as explained in the detailed description of FIGS. 2A-2E.

At block 11005, the method 11000 includes generating the digital token associated with the user account information, based on the verification of the user. For instance, the processor 2101 of the mobile device 2001 is configured as cryptographic key generation module 2121d for generating the digital token (for instance, the public key of the cryptographic key pair) associated with the user account information, if the identity of the user is verified.

FIG. 12 illustrates a flowchart showing a complete method 12000 for authenticating the user, in accordance with one or more example embodiments. The method 12000 may be used in conjunction with mobile device 2001 described in the detail description of FIGS. 2A-2H. Although various steps of method 12000 are described below and depicted in FIG. 12, the steps need not necessarily all be performed, and in some cases may be performed in a different order than the order shown.

Starting at block 12001, the method 12000 includes receiving, from the cloud server 2003, the push notification. For instance, the mobile device 2001 receives, from the server 2003, the push notification (i.e. the authentication response) for authenticating the user.

At block 12003, the method 12000 includes displaying, to the user, a confirmation screen (i.e. the confirmation interface) with receiver information in the push notification for an approval. For instance, the mobile device 2001 displays, to the user, a confirmation screen with receiver information in the push notification for the approval.

At block 12005, the method 12000 includes checking if user response data is ‘Yes’ or ‘No’. For instance, the mobile device 2001 receives the user response data on the displayed confirmation screen and checks if the user response data is ‘Yes’ or ‘No’. If the user response data is ‘NO’, then the method 12000 proceeds with block 12011.

At block 12011, the method 12000 includes generating a response indicating an invalid transaction. For instance, the mobile device 2001 generates the response indicating the invalid transaction. The method 12000, at block 12011, may further include transmitting, to the cloud server 2003, the response indicating the invalid transaction.

If the user response data is ‘Yes’, the method 12000 proceeds with block 12007. At block 12007, the method 12007 includes capturing a selfie video (i.e. the second facial data) of the user. For instance, the mobile device 2001 captures, using the front-facing camera, the selfie video of the user.

At block 12009, the method 12000 includes authenticating the user based on the captured selfie video. For instance, the mobile device 2001 authenticates the user as explained in the detailed description of FIG. 2G and FIG. 2H.

At block 12011, the method 12000 includes generating a response based on the authentication of the user. For instance, the mobile device 2001 generates a response indicating a valid transaction, if the user is authenticated as the valid user. The method 12000, at block 12011, may further include transmitting, to the remote authentication engine, the response indicating the valid transaction, if the user is authenticated as the valid user.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. An apparatus for authenticating a user, the apparatus comprising:
a memory configured to store:
computer-executable instructions; and
first data, wherein the first data comprises first user data and first behavioral data; and
one or more processors configured to execute the computer-executable instructions to:
receive, from a remote authentication engine, an authentication response for authenticating the user;
determine second data based on the received authentication response, wherein the second data comprises second user data and second behavioral data;
determine a first plurality of confidence scores, based on a first comparison of the second data and the first data;
determine a second confidence score based on the first plurality of confidence scores; and
authenticate the user based on the second confidence score, wherein the authentication is done based on a second comparison of the second confidence score with a threshold confidence score, and wherein the user is authenticated as a valid user when the second confidence score is greater than the threshold confidence score.

2. The apparatus of claim 1, wherein the one or more processors are further configured to execute the computer-executable instructions to:
display a confirmation user interface to the user based on receiving the authentication response from the remote authentication engine;
receive, on the displayed confirmation user interface, user response data;
capture current facial data of the user based on the received user response data, wherein the current facial data of the user comprises a selfie video of the user; and
authenticate the user based on the received user response data and the captured current facial data of the user.

3. The apparatus of claim 1, wherein:
the first data comprises the first user data and the first behavioral data, wherein the first user data comprises at least one of first password data associated with the user, first fingerprint data associated with the user, first facial data associated with the user or a combination thereof; and the first behavioral data comprises at least one of first location data associated with the user, first gait data associated with the user, first transaction data associated with the user, first network data associated with the user, first connection data associated with the user or a combination thereof; and
the second data comprises the second user data and the second behavioral data, wherein the second user data comprises at least second facial data associated with the user; and the second behavioral data comprises at least one of second location data associated with the user, second gait data associated with the user, second transaction data associated with the user, second network data associated with the user, second connection data associated with the user or a combination thereof.

4. The apparatus of claim 3, wherein the first data is previously stored data, and the second data is current data.

5. The apparatus of claim 4, wherein to determine the first plurality of confidence scores, the one or more processors are further configured to execute the computer-executable instructions to at least:
determine a facial confidence score based on comparing the second facial data and the first facial data;
determine a location confidence score based on comparing the second location data and the first location data;
determine a gait confidence score based on comparing the second gait data and the first gait data;
determine a transaction confidence score based on comparing the second transaction data and the first transaction data; and
determine a network confidence score based on comparing the second network data and the first network data.

6. The apparatus of claim 1, wherein to determine the second confidence score, the one or more processors are further configured to execute the computer-executable instructions to:
determine a weight associated with each of the first plurality of confidence scores;
determine a second plurality of weighted confidence scores, wherein the second plurality of weighted confidence scores comprising a weighted confidence score for each of the first plurality of confidence scores, wherein the weighted confidence score for each of the first plurality of confidence scores is obtained by multiplying a respective weight associated with each of the first plurality of confidence scores with the respective confidence score of the first plurality of confidence scores; and
determine the second confidence score based on a function of the determined second plurality of weighted confidence scores.

7. The apparatus of claim 6, wherein the function is at least one of a summation function and a sigmoid function.

8. The apparatus of claim 1, wherein the one or more processors are further configured to execute the computer-executable instructions to:
obtain, from the user, a user account information and a user identity information, wherein the user account information comprises at least a user email information, a user communication information, and a user password information, and wherein the user identity information comprises at least user image data, user financial data and user government id data;
verify an identity of the user based on the obtained user identity information; and
generate a digital token associated with the user account information based on the verification of the user, wherein the digital token comprises a cryptographic key pair.

9. The apparatus of claim 8, wherein the digital token is used to transmit an authentication request to the remote authentication engine and to receive the authentication response from the remote authentication engine.

10. A system for authenticating a user, the system comprising:
a memory configured to store:
computer-executable instructions; and
first data, wherein the first data comprises first user data and first behavioral data; and
one or more processors configured to execute the computer-executable instructions to:
receive, from a remote authentication engine, an authentication response for authenticating the user;
determine second data based on the received authentication response, wherein the second data comprises second user data and second behavioral data;
determine a first plurality of confidence scores, based on a first comparison of the second data and the first data;
determine a second confidence score based on the first plurality of confidence scores; and
authenticate the user based on the second confidence score, wherein the authentication is done based on a second comparison of the second confidence score with a threshold confidence score, and wherein the user is authenticated as a valid user if the second confidence score is greater than the threshold confidence score.

11. The system of claim 10, wherein, the one or more processors are further configured to execute the computer-executable instructions to:
display a confirmation user interface to the user based on receiving the authentication response from the remote authentication engine;
receive, on the displayed confirmation user interface, user response data;
capture current facial data of the user based on the received user response data, wherein the current facial data of the user comprises a selfie video of the user; and
authenticate the user based on the received user response data and the captured current facial data of the user.

12. The system of claim 10, wherein:
the first data comprises the first user data and the first behavioral data, wherein the first user data comprises at least one of first password data associated with the user, first fingerprint data associated with the user, first facial data associated with the user or a combination thereof; and the first behavioral data comprises at least one of first location data associated with the user, first gait data associated with the user, first transaction data associated with the user, first network data associated with the user, first connection data associated with the user, or a combination thereof; and
the second data comprises the second user data and the second behavioral data, wherein the second user data comprises at least second facial data associated with the user; and the second behavioral data comprises at least one of second location data associated with the user, second gait data associated with the user, second transaction data associated with the user, second network data associated with the user, second connection data associated with the user, or a combination thereof.

13. The system of claim 12, wherein the first data is previously stored data, and the second data is current data.

14. The system of claim 13, wherein to determine the first plurality of confidence scores, the one or more processors are further configured to execute the computer-executable instructions to at least:
determine a facial confidence score based on comparing the second facial data and the first facial data;
determine a location confidence score based on comparing the second location data and the first location data;
determine a gait confidence score based on comparing the second gait data and the first gait data;
determine a transaction confidence score based on comparing the second transaction data and the first transaction data; and
determine a network confidence score based on comparing the second network data and the first network data.

15. The system of claim 10, wherein to determine the second confidence score, the one or more processors are further configured to execute the computer-executable instructions to:
determine a weight associated with each of the first plurality of confidence scores;
determine a second plurality of weighted confidence scores, wherein the second plurality of weighted confidence scores comprise a weighted confidence score for each of the first plurality of confidence scores, wherein the weighted confidence score for each of the first plurality of confidence scores is obtained by multiplying a respective weight associated with each of the first plurality of confidence scores with the respective confidence score of the first plurality of confidence scores; and
determine the second confidence score based on a function of the determined second plurality of weighted confidence scores.

16. The system of claim 15, wherein the function is at least one of a summation function and a sigmoid function.

17. The system of claim 10, wherein the one or more processors are further configured to execute the computer-executable instructions to:
obtain, from the user, a user account information and a user identity information, wherein the user account information comprises at least a user email information, a user communication information, and a user password information, and wherein the user identity information comprises at least user image data, user financial data and user government id data;
verify an identity of the user based on the obtained user identity information; and
generate the digital token associated with the user account information based on the verification of the user, wherein the digital token comprises a cryptographic key pair.

18. The system of claim 17, wherein the digital token is used to transmit the authentication request to the remote authentication engine and to receive the authentication response from the remote authentication engine.

19. A method for authenticating a user, the method comprising:
storing first data, wherein the first data comprises first user data and first behavioral data;
receiving, from a remote authentication engine, an authentication response for authenticating the user;
determining second data based on the received authentication response, wherein the second data comprises second user data and second behavioral data;
determining a first plurality of confidence scores, based on a first comparison of the second data and the first data;
determining a second confidence score based on the first plurality of confidence scores; and
authenticating the user based on the second confidence score, wherein the authentication is done based on a second comparison of the second confidence score with a threshold confidence score, and wherein the user is authenticated as a valid user if the second confidence score is greater than the threshold confidence score.

20. The method of claim 19, further comprising:
displaying a confirmation user interface to the user based on receiving the authentication response from the remote authentication engine;
receiving, on the displayed confirmation user interface, user response data;
capturing current facial data of the user based on the received user response data, wherein the current facial data of the user comprises a selfie video of the user; and
authenticating the user based on the received user response data and the captured current facial data of the user.

21. The method of claim 19, wherein:
the first data comprises the first user data and the first behavioral data, wherein the first user data comprises at least one of first password data associated with the user, first fingerprint data associated with the user, first facial data associated with the user or a combination thereof; and the first behavioral data comprises at least one of first location data associated with the user, first gait data associated with the user, first transaction data associated with the user, first network data associated with the user, first connection data associated with the user, or a combination thereof; and
the second data comprises the second user data and the second behavioral data, wherein the second user data comprises at least second facial data associated with the user; and the second behavioral data comprises at least one of second location data associated with the user, a second gait data associated with the user, second transaction data associated with the user, second network data associated with the second user, second connection data associated with the user, or a combination thereof.

22. The method of claim 21, wherein the first data is previously stored data, and the second data is current data.

23. The method of claim 22, wherein determining the first plurality of confidence scores further comprise at least:
determining a facial confidence score based on comparing the second facial data and the first facial data;
determining a location confidence score based on comparing the second location data and the first location data;
determining a gait confidence score based on comparing the second gait data and the first gait data;
determining a transaction confidence score based on comparing the second transaction data and the first transaction data; and
determining a network confidence score based on comparing the second network data and the first network data.

24. The method of claim 19, wherein determining the second confidence score further comprises:
determining a weight associated with each of the first plurality of confidence scores;
determining a second plurality of weighted confidence scores, wherein the second plurality of weighted confidence scores comprise a weighted confidence score for each of the first plurality of confidence scores, wherein the weighted confidence score for each of the first plurality of confidence scores is obtained by multiplying a respective weight associated with each of the first plurality of confidence scores with the respective confidence score of the first plurality of confidence scores; and
determining the second confidence score based on a function of the determined second plurality of weighted confidence scores.

25. The method of claim 24, wherein the function is at least one of a summation function and a sigmoid function.

26. The method of claim 19, further comprising:
obtaining, from the user, a user account information and a user identity information, wherein the user account information comprises at least a user email information, a user communication information, and a user password information, and wherein the user identify information comprises at least user image data, user financial data and user government id data;
verifying an identity of the user based on the obtained user identity information; and
generating the digital token associated with the user account information based on the verification of the user, wherein the digital token comprises a cryptographic key pair.

27. The method of claim 26, wherein the digital token is used for transmitting an authentication request to the remote authentication engine and for receiving the authentication response from the remote authentication engine.

28. A computer program product comprising a non-transitory computer readable medium having stored thereon computer executable instruction which when executed by one or more processors, cause the one or more processors to carry out operations for authenticating a user, the operations comprising:
storing first data, wherein the first data comprises first user data and first behavioral data;
receiving, from a remote authentication engine, an authentication response for authenticating the user;
determining second data based on the received authentication response, wherein the second data comprises second user data and second behavioral data;
determining a first plurality of confidence scores, based on a first comparison of the second data and the first data;
determining a second confidence score based on the first plurality of confidence scores; and
authenticating the user based on the second confidence score, wherein the authentication is done based on a second comparison of the second confidence score with a threshold confidence score, and wherein the user is authenticated as a valid user if the second confidence score is greater than the threshold confidence score.

29. The computer program product of claim 28, wherein the operations further comprise:
displaying a confirmation user interface to the user based on receiving the authentication response from the remote authentication engine;
receiving, on the displayed confirmation user interface, user response data;
capturing current facial data of the user based on the received user response data, wherein the current facial data of the user comprises a selfie video of the user; and
authenticating the user based on the received user response data and the captured current facial data of the user.

30. The computer program product of claim 28, wherein:
the first data comprises the first user data and the first behavioral data, wherein the first user data comprises at least one of first password data associated with the user, first fingerprint data associated with the user, first facial data associated with the user or a combination thereof; and the first behavioral data comprises at least one of first location data associated with the user, first gait data associated with the user, first transaction data associated with the user, first network data associated with the user, first connection data associated with the user or a combination thereof; and
the second data comprises the second user data and the second behavioral data, wherein the second user data comprises at least second facial data associated with the user; and the second behavioral data comprises at least one of second location data associated with the user, second gait data associated with the user, second transaction data associated with the user, second network data associated with the user, second connection data associated with the user or a combination thereof.

31. The computer program product of claim 30, wherein the first data is previously stored data, and the second data is current data.

32. The computer program product of claim 31, wherein for determining the first plurality of confidence scores, the operations further comprise at least:
determining a facial confidence score based on comparing the second facial data and the first facial data;
determining a location confidence score based on comparing the second location data and the first location data;
determining a gait confidence score based on comparing the second gait data and the first gait data;
determining a transaction confidence score based on comparing the second transaction data and the first transaction data; and
determining a network confidence score based on comparing the second network data and the first network data.

33. The computer program product of claim 28, wherein for determining the second confidence score, the operations further comprise:
determining a weight associated with each of the first plurality of confidence scores;
determining a second plurality of weighted confidence scores, wherein the second plurality of weighted confidence scores comprise a weighted confidence score for each of the first plurality of confidence scores, wherein the weighted confidence score for each of the first plurality of confidence scores is obtained by multiplying a respective weight associated with each of the first plurality of confidence scores with the respective confidence score of the first plurality of confidence scores; and
determining the second confidence score based on a function of the determined second plurality of weighted confidence scores.

34. The computer program product of claim 33, wherein the function is at least one of a summation function and a sigmoid function.

35. The computer program product of claim 28, wherein the operations further comprising:
obtaining, from the user, a user account information and a user identity information, wherein the user account information comprises at least a user email information, a user communication information, and a user password information, and wherein the user identify information comprises at least user image data, user financial data and user government id data;
verifying an identity of the user based on the obtained user identity information; and
generating a digital token associated with the user account information based on the verification of the user, wherein the digital token comprises a cryptographic key pair.

36. The computer program product of claim 35, wherein the digital token is used for transmitting an authentication request to the remote authentication engine and for receiving the authentication response from the remote authentication engine.
